(19) United States
(12) Patent Application Publication
(10) Pub. No.: US 2007/0286524 A1
(43) Pub. Date: Dec. 13, 2007

(54) Camera Module and Mobile Terminal Having the Same

(76) Inventor: HEE BOK SONG, Mapo-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/761,137

(22) Filed: Jun. 11, 2007

(30) Foreign Application Priority Data
Jun. 9, 2006 (KR) 10-2006-0051725

(51) Int. Cl. G06K 9/40

(52) U.S. Cl. 382/275

(57) ABSTRACT

Disclosed is a camera module. The camera module can include a camera sensor, an RGB-YC_{b}Cᵣ conversion module, a biometric image processing filter, a noise elimination/reduction module, and a frame image data conversion module. The camera sensor can be capable of capturing biometric information of a user to generate an RGB image signal. The RGB-YC_{b}Cᵣ conversion module can convert the RGB image signal captured by the camera sensor into a YC_{b}Cᵣ image signal. The biometric image processing filter can perform filtering to increase a Y (brightness) component from the YC_{b}Cᵣ image signal. The noise elimination/reduction module can reduce or eliminate noise components from the YC_{b}Cᵣ image signal filtered by the biometric image processing filter. The frame image data conversion module can convert the YC_{b}Cᵣ image signal from which the noise components are eliminated or reduced into frame image data.

### CROSS REFERENCE TO RELATED APPLICATION

The present application claims the benefit under 35 U.S.C. § 119 of Korean Patent Application No. 10-2006-0051725, filed on Jun. 9, 2006, which is hereby incorporated by reference in its entirety.

### BACKGROUND

A camera module refers to means capable of obtaining an image. A camera module can be employed to a mobile terminal. Thus, the utility of the mobile terminal can be increased. Here, a mobile terminal includes a mobile phone as well as various wireless communication devices.

Recently, mobile wireless communication has shown a tendency to gradually expand its service area to business application fields such as banking, stock transacting, shopping, and so on. Current security authentication is mainly executed by inputting a social security number, a name, and a mobile terminal number, and downloading authentication software of a corresponding bank. This security system is vulnerable to hacking. Thus, the security system can be abused to leak personal information from ordinary users unfamiliar to the software, and can have a high possibility of being abused for various crimes.

For this reason, in order to reinforce security for user authentication in terms of security, online authentication, electronic approval, mobile banking, etc. based on the mobile terminal, a biometric security system (for facial recognition, fingerprint recognition, iris recognition, etc.) as illustrated in FIG. 1 has been proposed. First, a mobile terminal 110 obtains biometric information such as the face, fingerprint, or iris of a user 100 using a camera module 112 thereof. The obtained biometric information is sent to a server 120, and then the server 120 executes a security solution by determining whether or not the sent biometric information is matched with user information stored in a user data base 130.

However, the camera module of the related mobile terminal merely provides a function of capturing the face, fingerprints, or iris of the user, but it does not provide a function of converting captured image information into biometric information in hardware. In other words, the camera module of the related mobile terminal has a structure of merely capturing an image. The converting of the image into biometric information is accomplished using an image processing technique and an image recognition technique at a firmware platform of the mobile terminal. Then, the biometric information is sent to a server.

Thus, in the case of performing the image processing at the firmware platform using the unoptimized image information captured by the camera module, the mobile terminal has a high possibility of making an error in the image processing due to noise, etc., and is not used in a certain environment, for instance during the night. Further, because the image is processed for the image processing and the image recognition at the firmware platform of the mobile terminal, a long processing time is required. In addition, the camera module sends the image set in an ordinary mode rather than the image optimized for a biometric algorithm, so that the recognition performance itself is lowered when the image is processed at the firmware platform, and thus the possibility of making an error in the image processing becomes high.

### BRIEF SUMMARY

An embodiment provides a camera module and a mobile terminal having the same, in which biometric information can be extracted from a captured image in a rapid exact manner.

An embodiment provides a camera module. The camera module can include a camera sensor capturing biometric information of a user to generate an RGB image signal, an RGB-YC_{b}Cᵣ conversion module converting the RGB image signal captured by the camera sensor into a YC_{b}Cᵣ image signal, a biometric image processing filter performing filtering of increasing a Y (brightness) component from the YC_{b}Cᵣ image signal, a noise elimination module reducing or eliminating noise components from the YC_{b}Cᵣ image signal filtered by the biometric image processing filter, and a frame image data conversion module converting the YC_{b}Cᵣ image signal from which the noise components are reduced or eliminated into frame image data.

An embodiment provides a mobile terminal. The mobile terminal can include a camera sensor capturing biometric information of a user to generate an RGB image signal, a memory having a register in which a value of determining whether or not driving is performed in a biometric capture mode is set, an image signal processor converting the generated RGB image signal into a YC_{b}Cᵣ image signal when driven in the biometric capture mode, performing filtering of increasing a Y (brightness) component from the YC_{b}Cᵣ image signal, and eliminating or reducing noise components from the YC_{b}Cᵣ image signal to convert the YC_{b}Cᵣ image signal into frame image data, and a controller setting the value of determining whether or not driving is performed in the biometric capture mode to the register of the memory.

An embodiment provides an image processing method of a mobile terminal. The method can include: capturing, by a camera sensor, biometric information of a user to generate an RGB image signal; converting the RGB image signal into a YC_{b}Cᵣ image signal; reading in a register value in order to determine whether or not a current capture mode is a biometric capture mode; performing filtering of increasing a Y (brightness) component from the YC_{b}Cᵣ image signal when driven in the biometric capture mode as a result of the determination of the register value, and generating the YC_{b}Cᵣ image signal from which the noise components are reduced or eliminated; and converting the YC_{b}Cᵣ image signal from which the noise components are reduced or eliminated into frame image data.

### BRIEF DESCRIPTION OF THE DRAWINGS

FIG. 1 is a schematic view illustrating a system of obtaining biometric information of a user to execute authentication of the user using a related mobile terminal;

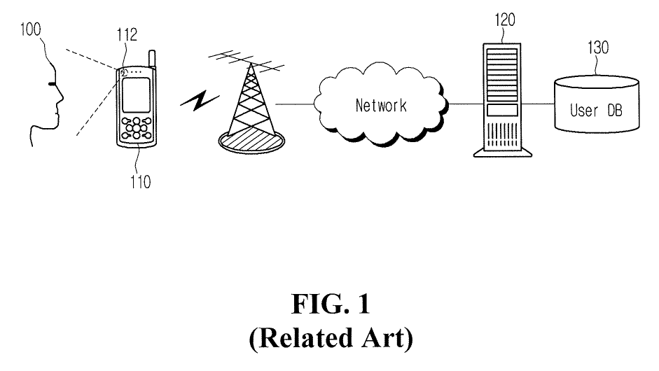

FIG. 2 is a schematic block diagram illustrating a mobile terminal according to an embodiment;

FIG. 3 is a schematic block diagram illustrating an image signal processor according to an embodiment; and

FIG. 4 is a flowchart illustrating an image processing method according to an embodiment.

### DETAILED DESCRIPTION

Hereinafter, a camera module and a mobile terminal having the same according to embodiments will be described with reference to the accompanying drawings.

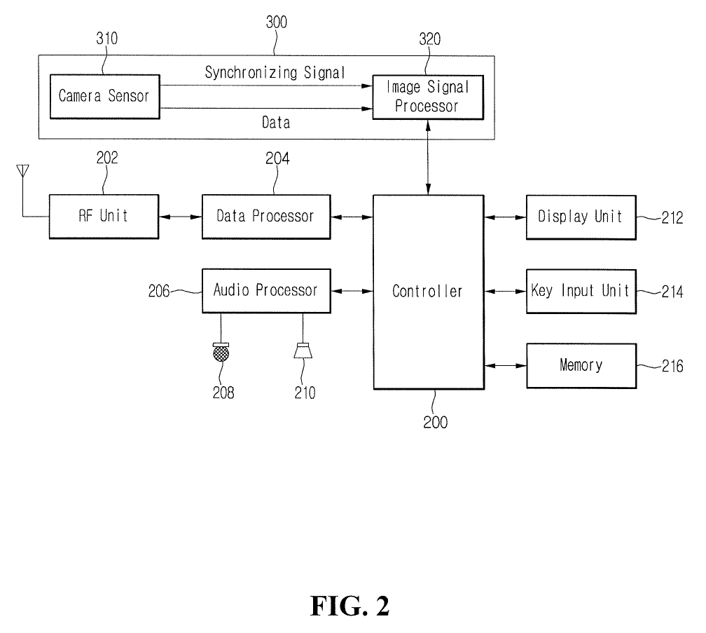

FIG. 2 is a schematic block diagram illustrating a mobile terminal according to an embodiment.

A radio frequency (RF) unit 202 can perform a wireless communication function of the mobile terminal. The RF unit 202 can include an RF transmitter that performs frequency up-conversion and amplification on a transmitted signal, and an RF receiver that performs frequency down-conversion and low-noise amplification on a received signal. A data processor 204 can include a transmitter that encodes and modulates the transmitted signal, and a receiver that demodulates and decodes the received signal. In other words, the data processor 204 can include a modem and a codec. Here, the codec can include a data codec processing packet data, etc., and an audio codec processing an audio signal such as voice.

An audio processor 206 can output the audio signal transmitted from the audio codec of the data processor 204 through a speaker 210. The audio processor 206 also functions to transmit an audio signal input from a microphone 208 to the audio codec of the data processor 204.

A memory 216 can include a program memory, a data memory, and so on. The program memory stores booting and operating system (OS) related software for controlling ordinary operation of the mobile terminal. The data memory stores various data generated during the operation of the mobile terminal. The memory can be provided as a module, which can input and output information, such as a flash memory, a compact flash (CF) card, a secure digital (SD) card, a smart media (SM) card), a multi-media (MM) card, or a memory stick. The memory can be mounted in the mobile terminal, or on a separate device.

A register value determining a capture mode can be set for the memory. As one example, when driven in a biometric capture mode, the register value is set to have “1” (true). When driven in an ordinary image capture mode, the register value is set to have “0” (false). Of course, the register value determining the capture mode can be set to another value.

A key input unit 214 can include keys for inputting information on figures and characters, and functional keys for setting various functions.

A display unit 212 can be implemented as a liquid crystal display or an organic light-emitting diode, and displays an image signal sent from an image signal processor 320 on a screen. Further, the display unit 212 displays user data output from a controller 200.

The controller 200 functions to control overall operation of the mobile terminal. The controller 200 can set the register value of the memory 216 to “1” (true) for the biometric capture mode when the driving of the biometric capture mode is selected through the key input unit 214. The image signal processor 320 can read the register value to determine whether a current mode is a biometric capture mode or an ordinary image capture mode. The controller 200 can drive a biometric image processing filter and a noise eliminator of the image signal processor 320 to enable a camera module 300 to capture an optimized biometric image.

In a mobile terminal according to an embodiment, the camera module 300 performs a function of capturing part of a user body such as a face, fingerprint, iris, or the like to convert it into a biometric image. The camera module 300 can include a camera sensor 310 to capture an image, and an image signal processor 320 to process the captured image into digital data.

As one example, the camera sensor 310 can be implemented as a charge coupled device (CCD) sensor or a complementary metal oxide semiconductor (CMOS) sensor, which captures an image to convert the captured optical signal into an electric signal. The image captured by the camera sensor 310 is sent to the image signal processor 320.

The image signal processor 320 functions to output image data for displaying the image signal transmitted from the camera sensor 310. The image signal processor 320 processes the image signal transmitted from the camera sensor 310 in unit of a frame, and outputs frame image data to correspond to characteristics and size of the display unit 212. Further, the image signal processor 320 can include a video codec, and functions to compress the frame image data displayed by the display unit 212 in a preset format, or restore the compressed frame image data into original frame image data. This video codec can include a joint photographic expert group (JPEG) codec, a moving picture experts group 4 (MPEG 4) codec, a wavelet codec, and so on.

The related image signal processor performs only an image processing procedure of converting an image received from the camera sensor 310 into frame image data en bloc, and then compresses the frame image data using a preset codec. Thus, in the case in which the face, fingerprint, iris, or the like is captured as the biometric information, the related mobile terminal converts the captured image into the frame image data through the image signal processor on the same basis. Then, using processing software, the controller generates the biometric information using a preset image processing technique and a preset image recognition technique. As such, the related mobile terminal requires a long time to extract the biometric information, and furthermore may extract incorrect information.

The mobile terminal according to an embodiment can further include a separate biometric image processing filter and noise elimination module within the image signal processor 320. According to an embodiment, the image signal processor 320 can first pre-process the image into an image optimized for the biometric information, and then can convert the pre-processed image into the frame image data.

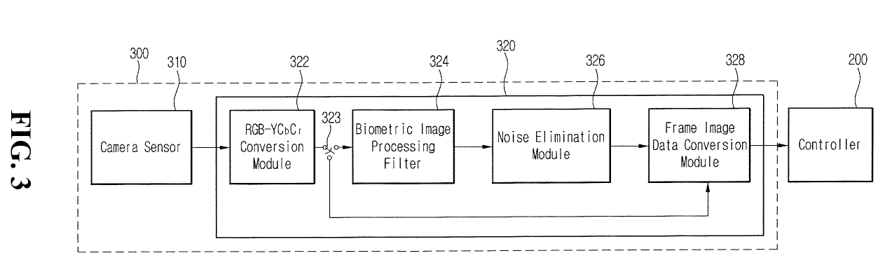

FIG. 3 is a schematic block diagram illustrating an image signal processor according to an embodiment.

The image signal processor 320 according to an embodiment can include an RGB-YC_{b}Cᵣ conversion module 322, a biometric image processing filter 324, a noise elimination module 326, and a frame image data conversion module 328.

In an embodiment of the image signal processor 320, the biometric image processing filter 324 and the noise elimination module 326 are provided between the RGB-YC_{b}Cᵣ conversion module 322 and the frame image data conversion module 328. The image signal processor 320 can perform pre-processing in order to obtain the biometric information from the captured image information.

Specifically, when the mobile terminal is operated in the biometric capture mode of capturing the face, fingerprint, or iris of the user in order to use it as the biometric information, the biometric image processing filter 324 and the noise elimination module 326 are driven. According to an embodiment, in the biometric image processing filter 324 and the noise elimination module 326, a YC_{b}Cᵣ image output from the RGB-YC_{b}Cᵣ conversion module 322 is pre-processed into an image optimized for use as the biometric information, and then is provided to the frame image data conversion module 328. When the mobile terminal is operated in the biometric capture mode, a signal output from the RGB-YC_{b}Cᵣ conversion module 322 is provided to the biometric image processing filter 324 through a switch 323.

The biometric image processing filter 324 performs filtering as the pre-processing capable of efficiently obtaining biometrically related characteristic information from the YC_{b}Cᵣ image converted by the RGB-YC_{b}Cᵣ conversion module 322. In operation, an RGB image signal is captured and generated by the camera sensor 310, and then is converted into an YC_{b}Cᵣ image signal through a YC_{b}Cᵣ color encoding system of the RGB-YC_{b}Cᵣ conversion module 322.

The YC_{b}Cᵣ color encoding system is used to split luminance from RGB color information, in which Y represents the brightness component, and C_{b} and Cᵣ represent the blue and red chroma components. A method of converting RGB into YC_{b}Cᵣ can be expressed by the following Equation 1.

Y=0.29900R+0.58700G+0.11400B

Cb=−0.16874R−0.33126G+0.50000B

Cr=0.50000R−0.41869G−0.08131B Equation 1

As described above, the RGB image signal can be converted into the YC_{b}Cᵣ image signal by the RGB-YC_{b}Cᵣ conversion module 322. At this time, the filtering to increase the Y (brightness) component excluding the C_{b} and Cᵣ chroma components from the converted YC_{b}Cᵣ image signal can be performed by the biometric image processing filter 324.

In this manner, a reason the biometric image processing filter 324 performs the filtering to increase the Y component is to promote characteristics of the image to enhance image recognition performance. In order to use the captured original image such as the face, fingerprint, or iris as a proper biometric image, the original image can be subjected to edge, dynamic range, and gamma handlings, and then tuning to emphasize a desired part of the image. According to an embodiment, the tuning can be properly performed by increasing the Y component.

After the filtering to increase the Y component is performed by the biometric image processing filter 324, the noise elimination module 326 eliminates or reduces noise that is not required to recognize the biometric information. Further, the noise elimination module 326 can reduce or eliminate unnecessary components impeding a recognition algorithm to increase recognition performance from the chroma signals. In the recognition of the biometric information, the unnecessary components that cause a main component to be incorrectly recognized are reduced or eliminated by the noise elimination module.

As described above, after the biometric image processing filter 324 and the noise elimination module 326 perform the pre-processing to increase the Y (brightness) component and reducing or eliminating the unnecessary noise, the frame image data conversion module 328 generates digital image data converted into the biometric information of a frame type. The frame image data conversion module 328 transmits the biometric information converted into the digital image data to the controller 200. The controller 200 directly transmits the biometric information processed in this way to a security server without separate processing, so that it can be authenticated by the security server. Therefore, the mobile terminal according to an embodiment can extract the biometric information in a rapid exact manner, and be stably authenticated by the security server.

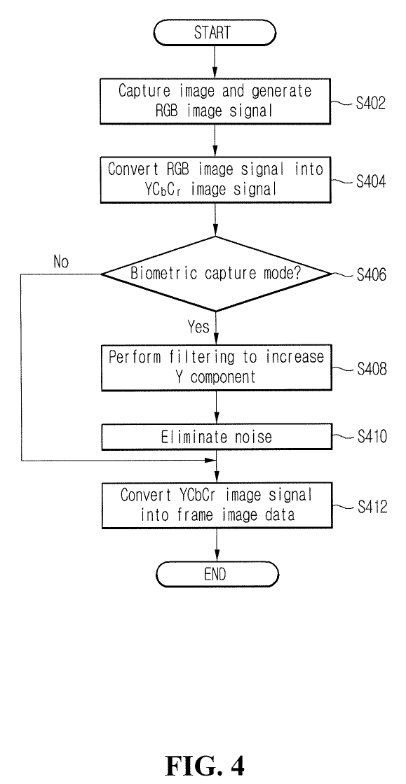

FIG. 4 is a flowchart illustrating an image processing method according to an embodiment.

First, when an image is captured by the camera sensor, an RGB image signal is generated (S402). The generated RGB image signal is converted into an YC_{b}Cᵣ image signal by the RGB-YC_{b}Cᵣ conversion module (S404). After the conversion into the YC_{b}Cᵣ image signal, the image signal processor determines whether or not a current state is driven in a biometric capture mode (S406). The determination of whether or not a current state is driven in a biometric capture mode can be performed by reading a preset register value. For example, when a user selects the driving of the biometric capture mode, the controller can set a particular register value to “1” (true). Thus, the image signal processor reads the particular register value, so that it can determine whether or not the current state is driven in the biometric capture mode.

As a result of the determination in step S406, in the case of an ordinary image capture mode rather than the biometric capture mode, the YC_{b}Cᵣ image signal converted in step S404 is directly converted into frame image data (S412). In contrast, in the case of the biometric capture mode, the filtering to increase a Y (brightness) component from the YC_{b}Cᵣ image signal is performed (S408).

A reason that the filtering to increase the Y component is performed in step S408 is to promote characteristics of the image to increase image recognition performance. In order to use a captured original image such as the face, fingerprint, iris, etc. as a proper biometric image, the original image can be subjected to edge, dynamic range, and gamma handlings, and then tuning to emphasize a desired part of the image. According to an embodiment, the tuning can be properly performed by increasing the Y component.

After the filtering, the filtered YC_{b}Cᵣ image signal is subjected to elimination or reduction of noise that is not required for the biometric information (S410), and then is converted into the frame image data (S412).

According to an embodiment, in the case of capturing the image for the biometric information, the camera module can perform the filtering and noise elimination or reduction in hardware such that the characteristics of the biometric information can be easily extracted. Thus, according to an embodiment, compared to the related method of generating the biometric information in software, the time required to extract the biometric information can be reduced. Further, according to an embodiment, the filtering and the noise elimination can be performed when the image is processed in the camera module, so that the accuracy of extracting the biometric information can be improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A camera module comprising:
a camera sensor to generate an RGB image signal, the camera sensor capable of capturing biometric information of a user;
an RGB-YC_{b}Cᵣ conversion module to convert the RGB image signal generated by the camera sensor into a YC_{b}Cᵣ image signal;
a biometric image processing filter to filter the YC_{b}Cᵣ image signal to increase a Y (brightness) component from the YC_{b}Cᵣ image signal;
a noise elimination module to reduce or eliminate noise components from the filtered YC_{b}Cᵣ image signal; and
a frame image data conversion module capable of converting the noise reduced or noise eliminated YC_{b}Cᵣ image signal into frame image data.

2. The camera module according to claim 1, wherein the biometric information is selected from facial information, fingerprint information, and iris information of the user.

3. A mobile terminal comprising:
a camera sensor to generate an RGB image signal, the camera sensor capable of capturing biometric information of a user;
a memory having a register in which a value is set for determining if driving is performed in a biometric capture mode;
an image signal processor capable of converting the generated RGB image signal into a YC_{b}Cᵣ image signal, and converting the YC_{b}Cᵣ image signal into frame image data, wherein when driven in the biometric capture mode, the image signal processor is capable of performing filtering to increase a Y (brightness) component from the YC_{b}Cᵣ image signal, and reducing or eliminating noise components from the filtered YC_{b}Cᵣ image signal before converting the YC_{b}Cᵣ image signal into frame image data; and
a controller capable of setting the value for determining if driving is performed in the biometric capture mode to the register of the memory.

4. The mobile terminal according to claim 3, wherein the value of the register is set to “1” when driven in the biometric capture mode, and to “0” when driven in an ordinary image capture mode.

5. The mobile terminal according to claim 3, wherein the image signal processor comprises:
a biometric image processing filter for performing the filtering to increase the Y (brightness) component from the YC_{b}Cᵣ image signal, and
a noise elimination module for reducing or eliminating the noise components from the filtered YC_{b}Cᵣ image signal.

6. The mobile terminal according to claim 5, wherein the image signal processor further comprises:
an RGB-YC_{b}Cᵣ conversion module for converting the generated RGB image signal into the YC_{b}Cᵣ image signal, and
a frame image data conversion module for converting the YC_{b}Cᵣ image signal into frame image data.

7. The mobile terminal according to claim 3, wherein the biometric information is selected from facial information, fingerprint information, and iris information of the user.

8. An image processing method of a mobile terminal comprising:
capturing biometric information of a user to generate an RGB image signal using a camera sensor;
converting the RGB image signal into a YC_{b}Cᵣ image signal;
reading a register value to determine if a current capture mode is a biometric capture mode; and
if the current capture mode is the biometric capture mode, the method comprising:
performing filtering of the YC_{b}Cᵣ image signal to increase a Y (brightness) component from the YC_{b}Cᵣ image signal;
generating a noise reduced or noise eliminated YC_{b}Cᵣ image signal; and
converting the noise reduced or noise eliminated YC_{b}Cᵣ image signal into frame image data.

9. The image processing method according to claim 8, wherein the biometric information is selected from facial information, fingerprint information, and iris information of the user.

10. The image processing method according to claim 8, wherein the register value is set to “1” when driven in the biometric capture mode, and to “0” when driven in an ordinary image capture mode.

11. The image processing method according to claim 10, wherein the register value is set to “1” or “0” by keyed input from the user.

12. The image processing method according to claim 8, wherein if the current capture mode is not the biometric capture mode, the method comprising:
converting the YC_{b}Cᵣ image signal into frame image data.
